(19) United States
(12) Patent Application Publication
(10) Pub. No.: US 2002/0078248 A1
(43) Pub. Date: Jun. 20, 2002

(54) Adapter module for a personal digital assistant and method for using the same

(76) Inventors: Craig M. Janik, Los Altos Hills, CA (US); Nick Kalayjian, San Francisco, CA (US); Bruce Edwards, Burlingame, CA (US); Josh Ferguson, San Francisco, CA (US)

Correspondence Address: Archana B. Vittal, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/946,567

(22) Filed: Sep. 4, 2001

Related U.S. Application Data
(60) Provisional application No. 60/230,084, filed on Sep. 5, 2000.

(51) Int. Cl. G06F 15/16

(52) U.S. Cl. 709/252; 709/250

(57) ABSTRACT

An adapter module for a personal digital assistant (PDA) and a method for using the same are provided. The adapter module includes a processing sub-system enclosed by a housing, and a first and second connector coupled to the processor. The first connector electrically connects to a corresponding connector on the PDA. This allows for communication between the adapter module and PDA. The second connector electrically connects to a corresponding connector on a PDA dock. This allows for communication between the adapter module and the PDA dock. The adapter module may be mechanically and electrically coupled to the PDA while the PDA is docked in the PDA dock.

This application claims the benefit of U.S. Provisional Application No. 60/230,084, filed Sep. 5, 2000, entitled “Home PC to PDA Data Transfer System”.

### RELATED APPLICATIONS

This application is related to U.S. Application entitled, “Webpad and Method for Using the Same”, filed Sep. 4, 2001, and commonly assigned herewith.

### FIELD OF THE INVENTION

The present invention relates generally to the field of personal digital assistants, and more particularly, to an adapter module for a personal digital assistant that provides additional functions, while allowing the personal digital assistant to be docked in its dock for charging and communication.

### BACKGROUND

Personal digital assistants (PDAs) and other portable handheld computers have achieved widespread market acceptance due to the valuable data manipulation, access, and storage functionality available in conveniently portable form factors. The innovation of pen-based user interfaces in combination with various types of character recognition technology has also been a factor in the high adoption rate of PDAs. Whereas previously handheld computers were used mainly in vertical markets, where they were called data-entry computers, PDAs are used widely in both consumer and vertical markets.

One example, the Palm Pilot®, in particular has advanced the state of the art of handheld computing by offering a small, light form factor with an effective character recognition application called Graffiti®. The Palm Pilot® uses the PalmOS® operating system. The Palm Pilot® is manufactured by Palm Computing, Inc. Other small form factor PDAs are available, such as the iPaq®, manufactured by Compaq Computer, Inc. Casio, Inc. offers the Cassiopeia®. Both the Cassiopeia® and iPaq® products use the WindowsCE or WindowsPocketPC operating systems, provided by Microsoft Corporation.

PDAs such as those mentioned above share a common feature in that they can be docked in a cradle for the purpose of charging the PDA internal batteries, and for connecting the PDA to a PC or network for the purpose of data synchronization and communication.

PDAs are made even more functional by the addition of communications and connectivity functions. Wired phoneline modems are available for Palm Pilots for gaining access to email and Internet browsing. An email client or browser application is required on the PDA. Using the wired systems, the communication function is operated with the PDA placed in the docking cradle. With the advent of wireless wide area network (WAN) telecommunications infrastructure, wireless modems have been introduced. Novatel, a wireless cellular equipment manufacturer, has teamed up with OmniSky, to offer the OmniSky® Wireless Modem. This device attaches mechanically to the back of the PalmV and connects electrically to the PalmV via the serial port that is accessed through the PalmV docking connector. The OmniSky wireless modem uses cellular digital packet data (CDPD) to communicate with existing cellular infrastructure.

Although the OmniSky modem attaches to the PalmV for use, it must be removed from the PalmV to place the PalmV in its docking cradle for charging and for HotSync® communication with a host PC. Users typically want to synchronize data between the host PC and the PalmV at least once a day if not more often. Therefore, users may end up detaching and re-attaching the OmniSky modem several times a day. Additionally, a separate AC power adapter must be plugged into a receptacle at the top of the OmniSky modem to charge the modem's internal battery.

Some PDAs include other features for adding functionality. The Cassiopeia E-125 and the Compaq iPaq for example include CompactFlash card slots for adding peripheral memory cards or cards that provide other functions such as wireless LAN transceivers.

One problem with using add-in cards like flash cards in slots in the iPaq and the Cassiopeia is that these peripheral items use power from the respective devices internal batteries. Depending on the function provided by the add-on card, the battery life of the PDA may be significantly shortened.

Therefore, what is desired, is an adapter module that provides additional functions to those of the PDA and may be connected to the PDA while the PDA is docked in its PDA dock.

### SUMMARY OF THE INVENTION

An adapter module for a personal digital assistant (PDA) and a method for using the same are provided. The adapter module includes a processing sub-system enclosed by a housing, and a first and second connector coupled to the processor. The first connector electrically connects to a corresponding connector on the PDA. This allows for communication between the adapter module and PDA. The second connector electrically connects to a corresponding connector on a PDA dock. This allows for communication between the adapter module and the PDA dock. The adapter module may be mechanically and electrically coupled to the PDA while the PDA is docked in the PDA dock.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only:

FIG. 1. is an isometric view of one embodiment of a conventional PDA with docking cradle;

FIG. 2. is an isometric right side view of one embodiment of the wireless LAN adapter module.

FIG. 3. is an isometric left side view of one embodiment of the wireless LAN adapter module attached to PDA.

FIG. 4. is an isometric rear view of one embodiment of the wireless LAN adapter module.

FIG. 5. is an isometric view of one embodiment of the wireless LAN adapter module and PDA separated.

FIG. 6. is an isometric exploded view of one embodiment of the wireless LAN adapter module.

FIG. 7. is an isometric exploded view of one embodiment of the wireless LAN adapter module with the wireless daughter-card separated.

FIG. 8. is a block diagram of one embodiment of the electrical hardware components of the wireless LAN adapter module for PDA; and

FIG. 9 is a side section view showing the profiles of one embodiment of the PDA, wireless LAN adapter module, and docking cradle.

### DETAILED DESCRIPTION

An adapter module for a personal digital assistant and method for using the same are described. In the following description, for purposes of explanation, numerous specific details are set forth in order to provide a thorough understanding of the present invention. It will be apparent, however, to one skilled in the art that the present invention can be practiced without these specific details. In other instances, well-known structures and devices are shown in block diagram form in order to avoid obscuring the present invention.

A set of definitions is provided below to clarify the present invention.

### Definitions

Personal digital assistants (PDAs) are defined as the category of computers that are small enough to be comfortably held in one hand, and that contain software applications that are used for personal organization, productivity, and communication. PDAs may also contain other software applications that may be used for many other applications, and are not necessarily limited to the applications specifically mentioned here.

The PDA category includes handheld computers, including single-housing devices such as the Palm Pilot, which have a two-piece clam-shell plastic housing with an integral display. There are also hinged designs for PDAs that are similar in configuration, although much smaller than, portable notebook computers. In this configuration, one housing contains the microprocessor, memory, batteries, and small keyboard, and the other housing contains a liquid crystal display (LCD).

### Description of System

In one embodiment, the adapter module is a wireless local area network (LAN) adapter module 14. The LAN adapter module 14 is connected to a PDA 2 for the purpose of adding functionality to PDA 2. In one embodiment, wireless LAN adapter module 14 provides wireless interconnection and additional processing functions to PDA.

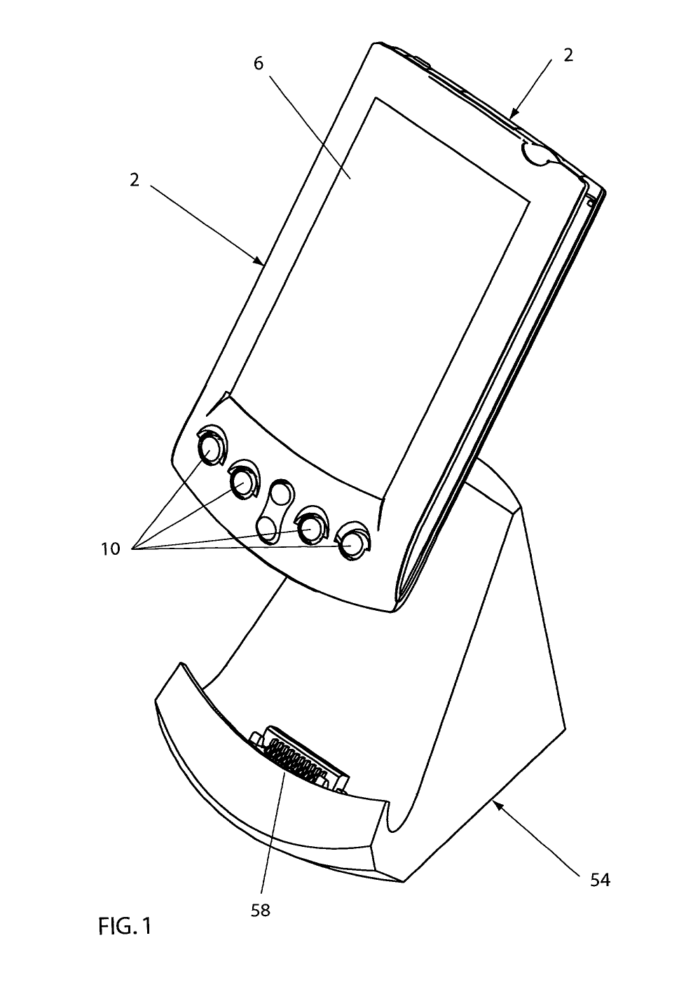

Referring now to FIG. 1, PDA 2 is shown. In one embodiment, the PDA 2 is a Palm V, made by Palm Computing. However, it should be noted that the PDA 2 may be any number type of PDA and is not necessarily limited to a Palm. PDA 2 includes a computer subsystem 8, an operating system, and a user interface input/output system that includes a touch-sensitive LCD 6 and a stylus. PDA 2 also includes control buttons 10 as part of the user interface sub-system.

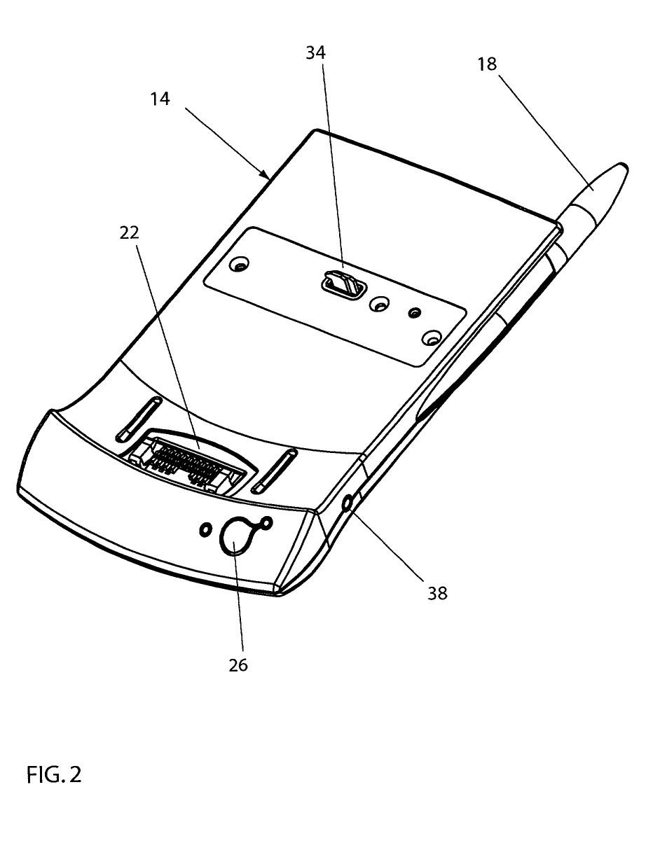

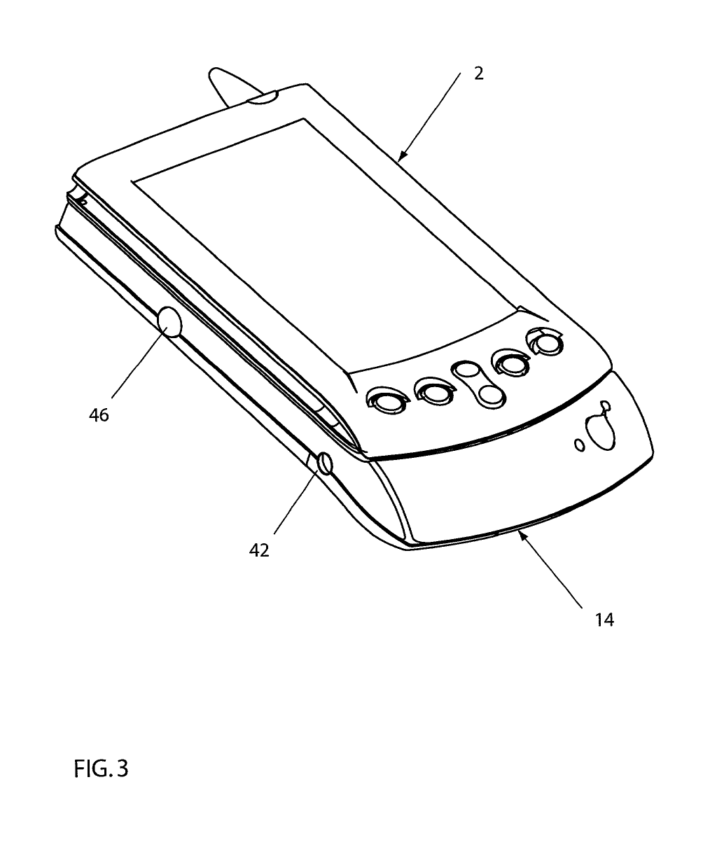

Referring now to FIG. 2, wireless LAN adapter module 14 is shown. In one embodiment, wireless LAN adapter module 14 includes a headset jack 38, a voice-over-IP answer button 26, and a molded antenna cover 18. FIG. 3, a left-side view of the wireless LAN adapter module 14 attached to PDA 2 shows an audio-out jack 42 and an adapter release button 46.

### Mechanical Description

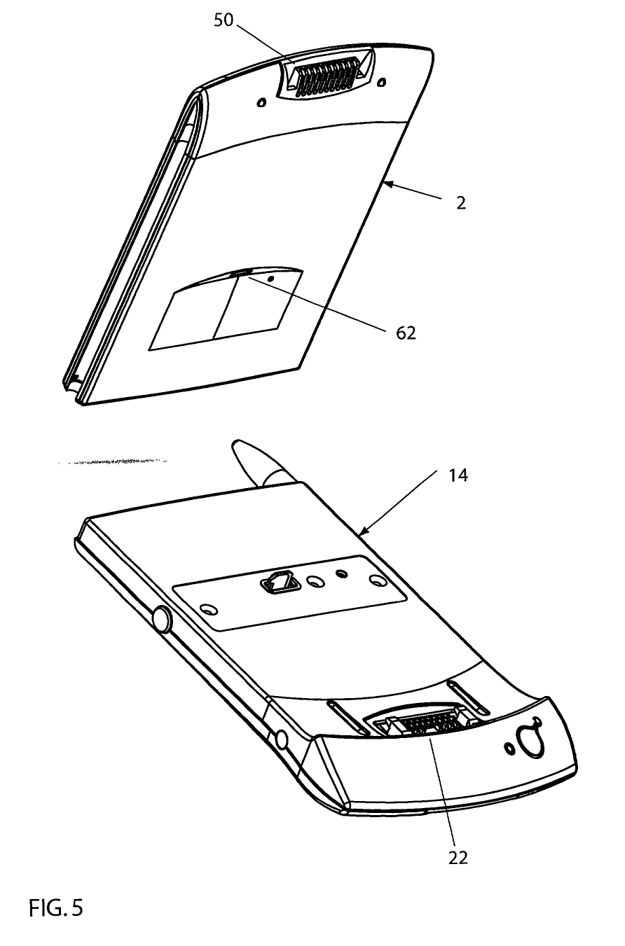

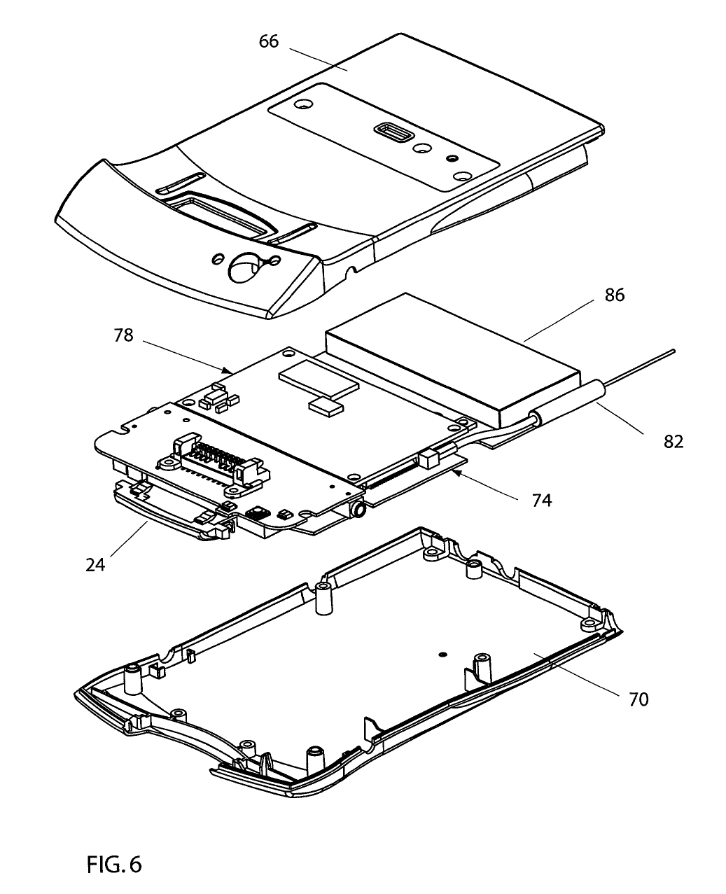

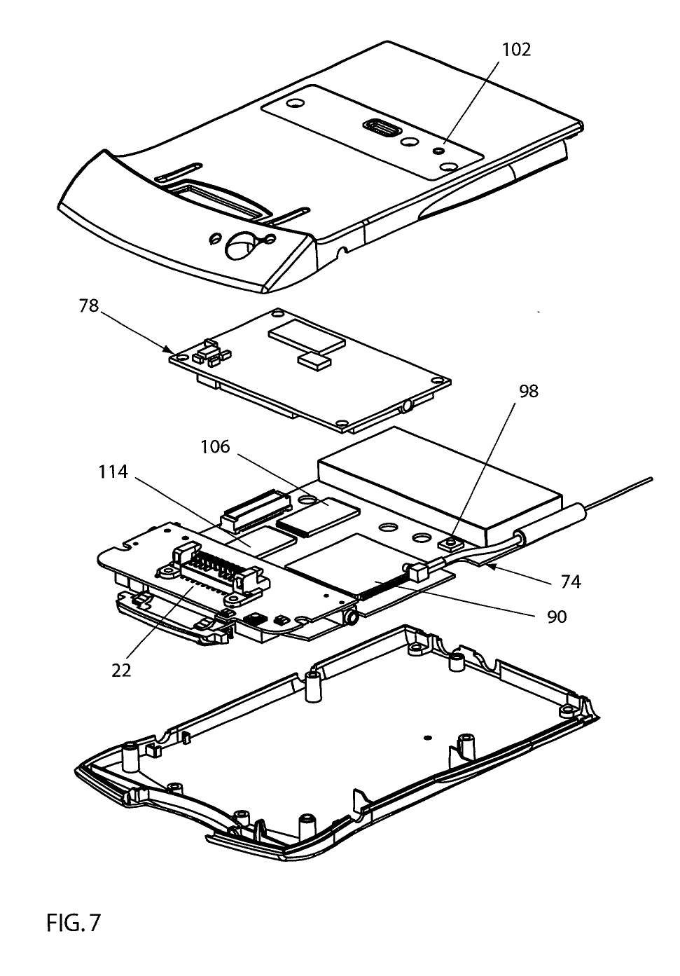

As shown in FIG. 6 and FIG. 7, wireless LAN adapter module 14 includes a top housing 66 and bottom housing 70 that together enclose a computer sub-system. In one example, as mentioned above, the PDA 2 can be a Palm. The mechanical design for attaching the wireless LAN adapter module 14 to a Palm may be found in a reference design document provided by Palm Computing. FIG. 2 shows a fastener, a latch hook 34, that is part of a sheet-metal spring-loaded latch system. Latch hook is inserted into a latch hole 62 on the rear side of PDA 2, shown in FIG. 5.

An important feature of the invention is the arrangement of connectors and the shape of the enclosure created by the combination of top housing 66 and bottom housing 70. FIG. 2 shows a first connector, an adapter-to-PDA connector 22, protruding through the top housing 66 in wireless LAN adapter module 14. Adapter-to-PDA connector 22 is identical electrically and mechanically to the cradle connector 58, shown in FIG.

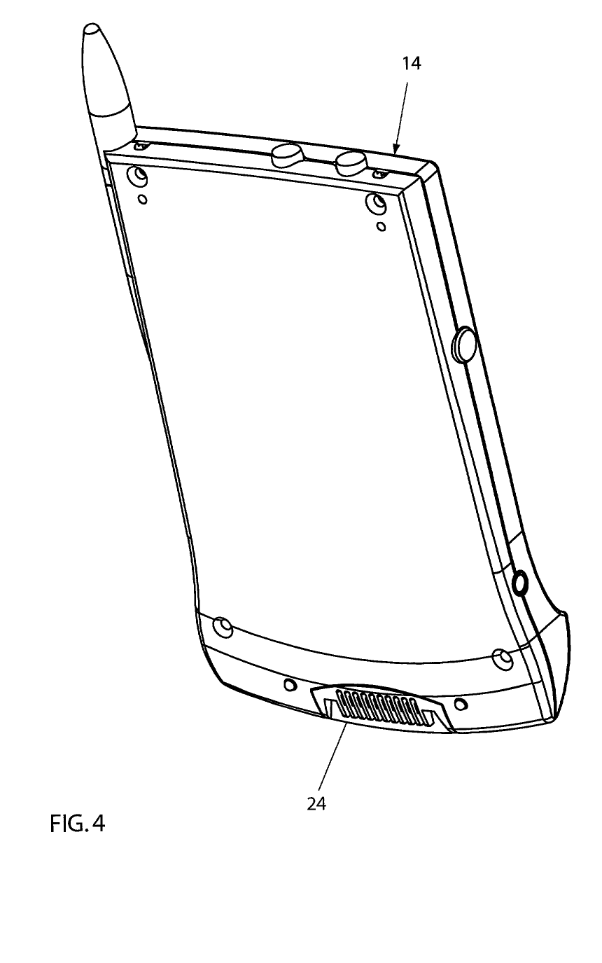

FIG. 4 shows a second connector, an adapter-to-cradle connector 24, exposed but flush with bottom housing 70 in wireless LAN adapter module 14. Adapter-to-cradle connector 24 is identical electrically and mechanically to PDA connector 50, shown in FIG. 5.

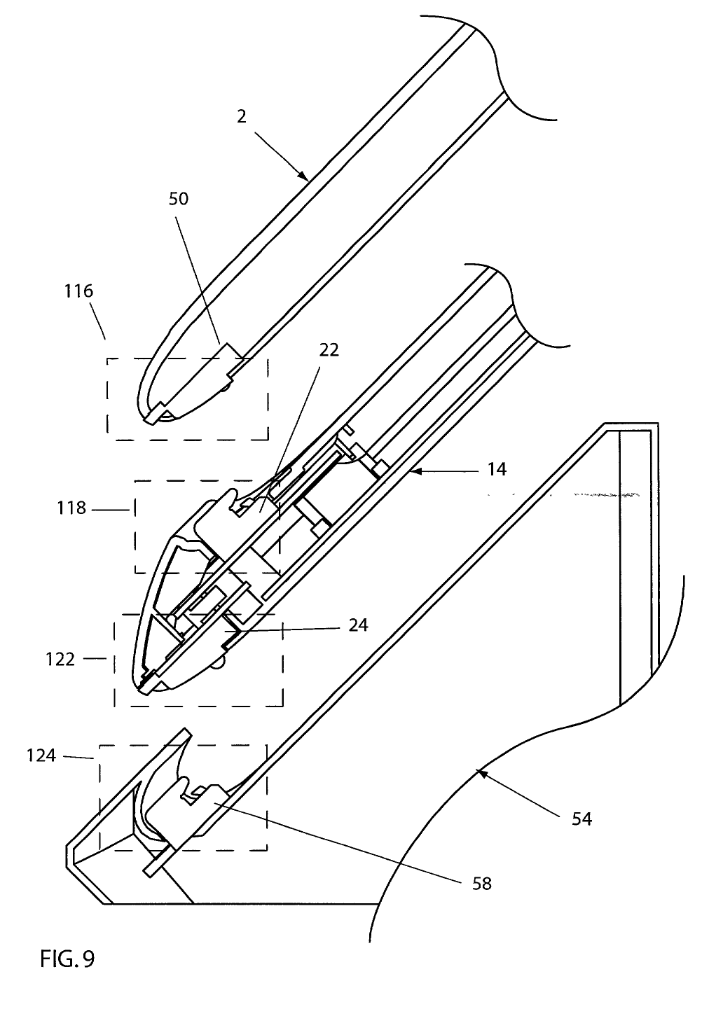

Referring now to FIG. 9, PDA docking profile area 116 of PDA 2 is shaped to fit into cradle docking profile area 124 when PDA 2 is docked with PDA docking cradle 54. The shape of wireless LAN adapter module 14 in the adapter-to-PDA docking profile area 118 is the same shape as the cradle docking profile area 124 in PDA docking cradle 54.

Likewise, the shape of adapter-to-cradle profile area 122 on wireless LAN adapter module 14 is the same as the shape of PDA docking profile area 116 on PDA 2. The location of adapter-to-PDA connector 22 with respect to adapter-to-PDA profile area 118 is such that PDA 2 can be placed in wireless LAN adapter module 14 and is compatible both mechanically and electrically. The location of adapter-to-cradle connector 24 with respect to adapter-to-cradle profile area 122 is such that wireless LAN adapter module 14 can be placed in PDA docking cradle 54 and is compatible both mechanically and electrically. Latch hook 34 on wireless LAN adapter module 14 placed into latch hole 62 on PDA 2 provides a mechanical connection between PDA 2 and wireless LAN adapter module 14.

### Electrical Description

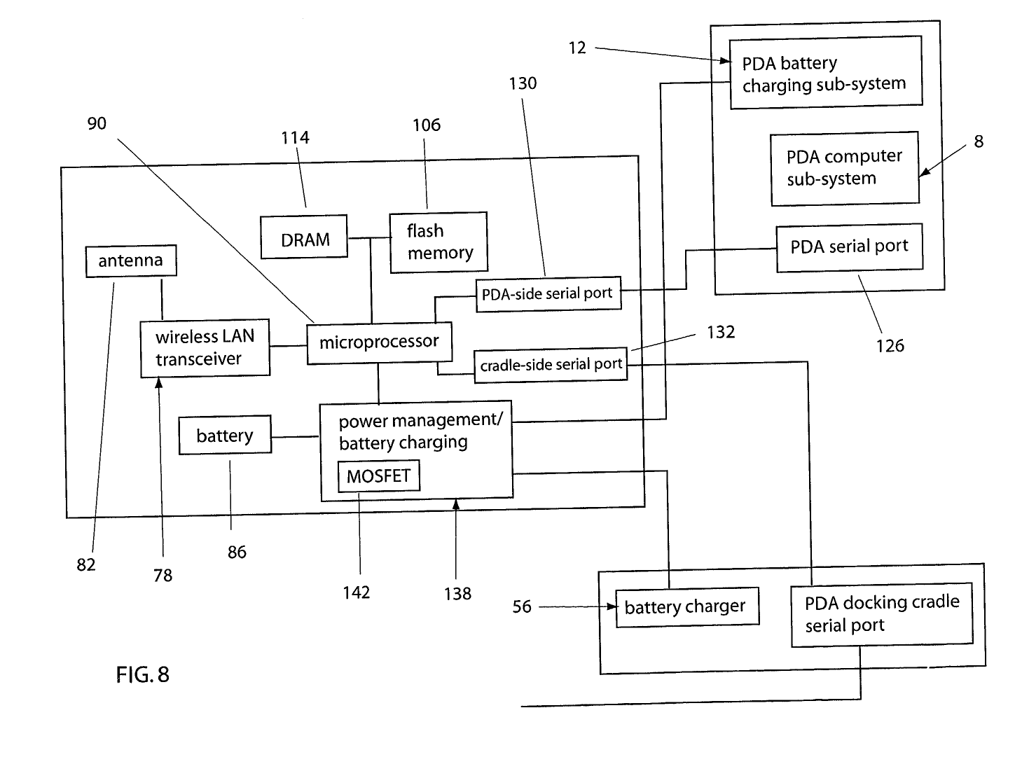

Referring now to FIG. 6, FIG. 7, and FIG. 8, the computer sub-system in wireless LAN adapter module 14, in one embodiment, includes a microprocessor 90, DRAM memory 114, flash memory 106, a power management sub-system 138, a battery 86, a wireless LAN transceiver 78 and an antenna 82.

FIG. 6 shows wireless LAN transceiver 78 daughter-card connected to the motherboard 74, and FIG. 7 shows wireless LAN transceiver 78 daughter-card separated from motherboard 74. In one embodiment, wireless LAN transceiver 78 daughter-card uses the HomeRF wireless data transfer protocol based on RF modulation centered on the 2.4 GHz frequency band, and is provided by Proxim, Inc. Such LANs have a practical indoor range of approximately 150 feet.

In another embodiment, the wireless LAN transceiver 78 daughter-card uses the 802.11 b wireless communication protocol. And in another embodiment, the wireless LAN transceiver 78 daughter-card uses the Bluetooth wireless communication protocol. A microprocessor 90 reset switch 98 is included on motherboard 74 and is accessible using a paper clip through reset switch hole 102 on top housing 66.

In one embodiment, wireless LAN adapter module 14 also includes a real-time operating system and control firmware 92, both stored in flash memory 106 and executed by microprocessor 90.

### Pass Through Serial Port Mode

Referring now to FIG. 6, FIG. 7, and FIG. 8, in one embodiment, a PDA-side serial port 130 is functionally connected to adapter-to-PDA connector 22, and is an EIA/TIA-562 compliant serial port. A first serial port, cradle-side serial port 132, is functionally connected to adapter-to-cradle connector 24, and is an EIA/TIA-562 compliant serial port. The inclusion of PDA-side serial port 130 cradle-side serial port 132 on wireless LAN adapter module 14 provides the ability for PDA 2 standard serial port communication functions to occur while wireless LAN adapter module 14 is connected to PDA 2, such as PDA 2 to PC data synchronization or the use of a keyboard peripheral.

When conventional serial data is present at cradle-side serial port 132, control firmware 92 running on microprocessor 90 recognizes this and coordinates the transfer of serial data from cradle-side serial port 132 to PDA-side serial port 130, so that the serial data is present at PDA serial port 126. Conventional serial data is effectively transferred between a serial peripheral device such as docking cradle 54 and PDA 2 as if wireless LAN adapter module 14 were not present.

### Packetized Data Mode

In one embodiment, packetized data from wireless LAN transceiver 78 can also be transferred to PDA 2 via PDA-side serial port 130. Control firmware 92 running on microprocessor 90 operates a point-to-point protocol (PPP) network connection between PDA 2 and wireless LAN adapter module 14 using PDA-side serial port 130 and PDA serial port 126. PDA 2 also includes PPP software running on PDA 2 computer sub-system 8. Control firmware 92 manages the transfer of packet data from the LAN, through wireless LAN adapter module 14, to PDA 2.

In the case where both a serial peripheral device, such as docking cradle 54 and a PPP connection are desired simultaneously, control firmware 92 will packetize conventional serial data present on cradle-side serial port 132 and transfer the packets to PDA 2 using the established PPP connection. PPP to serial conversion software on PDA 2 translates the transferred packets into the original serial data. A serial port emulation software application on PDA 2 will process the translated data as if it were received as conventional serial data.

### Device Charging Management

In one embodiment, PDA adapter serial port 130 also allows for connection with PDA 2 battery charger 56 which is an integral function provided by PDA docking cradle 54. When battery charger 56 is connected to wireless LAN adapter module 14 through adapter-to-cradle connector 24, it charges both battery in PDA 2 and battery 86 in wireless LAN adapter module 14. The charging function, controlled by control firmware 92 running on microprocessor 90, is dependent on the type of battery technology used in PDA 2 and wireless LAN adapter module 14.

For example, standard procedure for charging lithium batteries does not allow for both batteries to be charged simultaneously. Thus, microprocessor 90 may be programmed to determine which battery to charge by monitoring the charge levels of each battery and charging the battery with the smaller charge first. When that battery reaches 100 percent charge, the charger begins charging the other battery. The wireless LAN adapter module 14 includes a MOSFET circuit 142, an electrically controlled, very low resistance analog switch, which allows the charger to electrically connect with and disconnect from the appropriate battery.

MOSFET circuit 142 also ensures that a loss is not introduced between battery charger 56 and the battery being charged, due to its very low resistance.

### Bar Code Scanner

In alternative embodiments, many other functional applications exist for add-on adapters for PDAs. For example, bar code scanners are used in many industries such as retailing, manufacturing, and in hospitals. A bar code scanning sub-system can be designed into the wireless LAN adapter module 14 and the PDA's interface can be used to control the functions of the bar scanner. Accordingly, the adapter module is not limited to the functions discussed specifically here. Alternative embodiments exist in which the adapter module may be used for numerous other applications.

An adapter module for a personal digital assistant and method for using the same have been described. Although the present invention is described herein with reference to specific embodiments, many modifications and variations therein will readily occur to those with ordinary skill in the art. Accordingly, all such variations and modifications are included within the intended scope of the present invention as defined by the following claims.

What is claimed is:

1. An adapter module comprising:
a housing;
a processing sub-system enclosed in the housing;
a first connector for electrically connecting to a corresponding connector on a personal digital assistant (PDA) to allow communication between the adapter module and the PDA, the first connector coupled to the processing sub-system; and
a second connector for electrically connecting to a corresponding connector on a PDA dock to allow communication between the adapter module and the PDA dock, the second connector coupled to the processing sub-system.

2. The adapter module of claim 1 wherein the housing is shaped so that the adapter module is capable of being mechanically and electrically coupled to the PDA while the PDA is docked in the PDA dock.

3. The adapter module of claim 1 further comprising a fastener protruding from the housing to mechanically connect the adapter module to the PDA.

4. The adapter module of claim 1 further comprising:
an antenna; and
a wireless transceiver coupled to the antenna to send and receive data via a wireless communication standard.

5. The adapter module of claim 4 wherein the wireless communication standard is IEEE 802.1 b.

6. The adapter module of claim 4 wherein the wireless communication standard is Bluetooth™.

7. The adapter module of claim 1 further comprising a battery.

8. The adapter module of claim 7 further comprising a circuit to allow the PDA dock to charge the battery in the adapter module.

9. The adapter module of claim 8 wherein the circuit is a Metal Oxide Semiconductor Field Effect Transistor (MOSFET) circuit.

10. The adapter module of claim 1 wherein the processing sub-system includes a bar code scanning sub-system.

11. The adapter module of claim 3 wherein the fastener is a latch hook to be inserted into a latch hole on the personal digital assistant.

12. A system comprising:
a personal digital assistant (PDA);
an adapter module capable of being mechanically and electrically coupled to the PDA while the PDA is docked in a PDA dock, the adapter module including a processing sub-system enclosed in the housing, a first connector for electrically connecting to a corresponding connector on a personal digital assistant (PDA) to allow communication between the adapter module and the PDA, the first connector coupled to the processing sub-system, and a second connector for electrically connecting to a corresponding connector on a PDA dock to allow communication between the adapter module and the PDA dock, the second connector coupled to the processing sub-system.

13. The system of claim 12 wherein the housing is shaped so that the adapter module is capable of being mechanically and electrically coupled to the PDA while the PDA is docked in the PDA dock.

14. The system of claim 12 further comprising a fastener protruding from the housing to mechanically connect the adapter module to the PDA.

15. The system of claim 12 further comprising:
an antenna; and
a wireless transceiver coupled to the antenna to send and receive data via a wireless communication standard.

16. The system of claim 15 wherein the wireless communication standard is IEEE 802.11 b.

17. The system of claim 15 wherein the wireless communication standard is Bluetooth™.

18. The system of claim 12 further comprising a battery.

19. The system of claim 18 further comprising a circuit to allow the PDA dock to charge the battery in the adapter module.

20. The system of claim 19 wherein the circuit is a Metal Oxide Semiconductor Field Effect Transistor (MOSFET) circuit.

21. The system of claim 12 wherein the processing sub-system includes a bar code scanning sub-system.

22. The adapter module of claim 14 wherein the fastener is a latch hook to be inserted into a latch hole on the personal digital assistant.

23. A method of obtaining data using an adapter module comprising:
mechanically attaching the adapter module to a personal digital assistant (PDA) using a fastener;
electrically connecting a first connector on the adapter module to a corresponding connector on the PDA to allow communication between the adapter module and PDA, the first connector coupled to a processing sub-system in the adapter module;
placing the PDA with the adapter module attached in a PDA dock;
electrically connecting a second connector on the adapter module to a corresponding connector on the PDA dock to allow communication between the adapter module and the PDA dock, the second connector coupled to the processing sub-system in the adapter module; and
the adapter module obtaining data from the PDA dock via the second connector, the PDA dock receiving data from a remote location.

24. The method of claim 23 wherein the remote location is a computer system.

25. The method of claim 23 further comprising the adapter module sending the data obtained from the PDA dock to the PDA via the first connector.

26. The method of claim 23 wherein the data includes MP3 files to be played by the PDA.

27. The method of claim 23 further comprising charging a battery in the adapter module using the PDA dock.
